(19) United States
(12) Patent Application Publication
(10) Pub. No.: US 2009/0236379 A1
(43) Pub. Date: Sep. 24, 2009

(54) BAG HAVING A SHOPPING TROLLEY INSERT

(76) Inventors: Cheryl Leanne Johnston, Yokine (AU); Mark Andrew Johnston, Yokine (AU)

Correspondence Address: CHARTER IP, LLC, P.O. BOX 64, The Plains, VA, 20198, US

(21) Appl. No.: 12/400,869

(22) Filed: Mar. 10, 2009

(30) Foreign Application Priority Data
Mar. 10, 2008 (AU) 2008901130

(51) Int. Cl. A45F 4/02; B60R 11/00

(52) U.S. Cl. 224/155; 224/486

(57) ABSTRACT

A bag assembly (20) comprises a bag (15) having an insert (16) attached thereto. The insert (16) has stowed and operative conditions. In the stowed condition, the insert (16) is accommodated within a pocket (74) within the bag (15). In the operative condition, the insert (16) extends from the bag (15) so that the insert and the bag can be so positioned as to substantially cover the internal surfaces of a toddler seat (114) of a shopping trolley (100), as well as portions of the trolley, including nearby top edges of the basket portion (104) and the handlebar (122) of the shopping trolley.

### BACKGROUND

1. Field

The present invention relates to a bag having a shopping trolley insert. The invention also relates to a shopping trolley insert.

2. Related Art

The following discussion of the background art is intended to facilitate an understanding of the present invention only. The discussion is not an acknowledgement or admission that any of the material referred to is or was part of the common general knowledge as at the priority date of the application.

Shopping trolleys (known also as shopping carts) are supplied by shops, and in particular supermarkets, for use by customers to carry merchandise while shopping. Shopping trolleys may incorporate a seating arrangement for carrying a small child (commonly called a toddler) while a customer is shopping. Typically, such a seating arrangement is of collapsible construction for movement between a collapsed condition so as to not occupy unnecessary space within the shopping trolley when not required and an erected condition to receive a small child.

The term toddler as used herein is intended to include any infant or child carried in the seating arrangement of a shopping trolley.

The inventors have previously developed a shopping trolley insert comprising padded material shaped to line the toddler seat of a shopping trolley to provide comfort for the toddler and also provide protection from germs and bacteria which may be present on parts of the trolley with which the toddler could make contact. The insert can also be used as a pillow, a change mat or an insert for baby seats for trolleys.

The present invention seeks to provide a product which provides further advantages to the above insert.

### SUMMARY

The present invention provides a bag having a shopping trolley insert attached thereto adapted to substantially cover internal surfaces of a toddler seat of the shopping trolley in use, the bag having a pocket into which the insert can be received.

Preferably, the insert is foldable to assume a compact configuration for reception in the pocket.

The insert is preferably attached adjacent a bottom portion of the bag. The pocket preferably has an opening at or adjacent the bottom portion of the bag.

Preferably, the bag is configured to be received on a backrest portion of the toddler seat. For this purpose, the pocket is preferably configured to receive the backrest portion.

The present invention also provides a shopping trolley insert for substantially covering internal surfaces of a toddler seat of the shopping trolley in use, the insert having a base portion, a back portion and a front portion extending from opposite sides of the base portion, and a pocket formed at one side of the back portion, an opening of the pocket being adjacent the base portion such that the base portion and the front portion can be inserted into the pocket.

Preferably, the base portion and the front portion are adapted to be folded for insertion into the pocket.

The insert preferably includes side portions extending from lateral sides of the base portion. An internal side of the insert preferably substantially consists of flat padded material. An elasticised pocket is preferably formed at one of the side portions.

The back portion is preferably rectangular in shape and extends from two corners of the base portion. The side portions preferably each include side edges that extend from a corner of the base portion. The respective side edges preferably diverge from each other from the base portion. One or more attachment elements, such as hook straps, are preferably attached to each of the edges of the side portions. Alternatively, one side edge of the side potions is preferably attached to the front portion.

The front portion preferably includes a leg section adjacent the base portion and a handlebar section extending from the leg section. The leg section preferably includes side edges which extend from the base portion, inwardly from corners of the base portion. The side edges preferably diverge from each other until they join the edges of the handlebar section which is rectangular. Leg apertures are preferably formed in the leg section, which are substantially covered by flaps extending from a side of the aperture adjacent the base portion.

The internal side of the insert is preferably shaped to cover the internal surfaces of a shopping trolley seat for a toddler.

An external side of the handlebar section of the front portion preferably includes one or more attachment elements, such as hook fasteners and loop straps, for attaching around a handlebar of a trolley.

The bag preferably includes the back portion which is connected to a front panel by side panels and a top panel thus forming a volume there between. This volume is preferably partly covered by a bottom panel which extends from the front panel to about halfway toward the back panel. An internal panel preferably extends vertically upward from the bottom panel and joined by a joining panel which extends to the back panel to partly close the volume and thus form an internal bag volume. A part of the volume which is not closed forms an upside down pocket accessible via a bottom opening which is the gap between the bottom panel and the back panel. This pocket is thus bounded by the back portion, the internal panel, the joining panel and portions of the side panels.

The front panel at its outside surface preferably includes storage pockets as desired. The side panels preferably include attachments for attaching a shoulder strap thereto. The top panel preferably includes a zip for accessing the internal bag volume. A further closure panel preferably extends from the back portion and substantially covers the top panel and the front panel when attached to the front panel via buckles. A hand strap is preferably attached to the closure panel.

In folding the insert for transport, the front portion, side portions and base portion are preferably folded to fit into the space of the pocket. Preferably, the insert when folded has the appearance of a bag and can be carried as such via a hand strap or shoulder strap.

In one embodiment, the insert is detachable from the bag. The detachable connection is preferably by means of a zip, hook and loop fastener (VELCRO) or button connection between the bag and the insert.

In use, the insert is unfolded and inserted into a toddler seat of a shopping trolley such that the backrest portion of the toddler seat is inserted into the space of the pocket. The base portion covers the base portion of the toddle seat. The side portions cover the sides of the toddler seat and extend over the side edges of same. An attachment element (such a hook strap) on the side portion can then be attached to a corresponding attachment element (such as a loop strap) on the back section. The front portion leg section covers the front portion of the toddler seat which the toddler faces in use. The apertures in the leg section correspond to the leg apertures of the toddler seat and the flaps will extend through the leg apertures in use. The handlebar section extends over the handlebar of the trolley. Attachment elements (such as hook straps) on the side portions are attached to corresponding attachment elements (such as loop straps) on the front portion to secure the insert to the toddler seat.

The insert can also be modified to include a safety belt. The safety belt will prevent a toddler from standing from the toddler seat. Further, the safety belt can include an electronic monitoring system, where unauthorised tampering or removing of the safety belt or any attempts to do such will trigger an alarm carried by the parent. The alarm can include a flashing light or vibrations produced by a module attached to the wrist of the parent. This will notify the parent/guardian immediately of any such attempted tampering or removal of the safety belt, which may also include attempts by the toddler.

The alarm can also be activated if the parent's module moves beyond a predetermined desired distance from the toddler in the insert. The alarm will stop once the parent's module is within the desired distance. When the safety belt is fastened around the toddler, a light in the parent's module will indicate that the unit is operational. The safety belt is desirably only undone by having the parent's module in close proximity to the safety belt.

The present invention provides a shopping trolley insert having a base portion, a back portion and a front portion extending from opposite sides of the base portion, and a pocket formed at one side of the back portion or the front portion, an opening of the pocket being adjacent the base portion such that the base portion and the other of the back portion and the front portion can be folded and inserted into the pocket.

### BRIEF DESCRIPTION OF THE DRAWINGS

The invention will be better understood by reference to the following description of several specific embodiments thereof as shown in the accompanying drawings.

FIG. 1 is a perspective view of a shopping trolley with a toddler seat ready to receive a bag assembly comprising a bag having a trolley insert according to a preferred embodiment of the present invention.

FIG. 2 is a front perspective view of the assembly when installed in the shopping trolley.

FIG. 3 is a rear perspective view of the arrangement shown in FIG. 2.

FIG. 4 is a top perspective view of the bag assembly.

FIG. 5 is a bottom perspective view of the bag assembly.

FIGS. 6 to 12 show the sequential steps in folding the insert and positioning it in a stowed condition within the bag.

FIG. 13 shows a rear perspective view of the bag when the insert is assembled for use.

### DETAILED DESCRIPTION

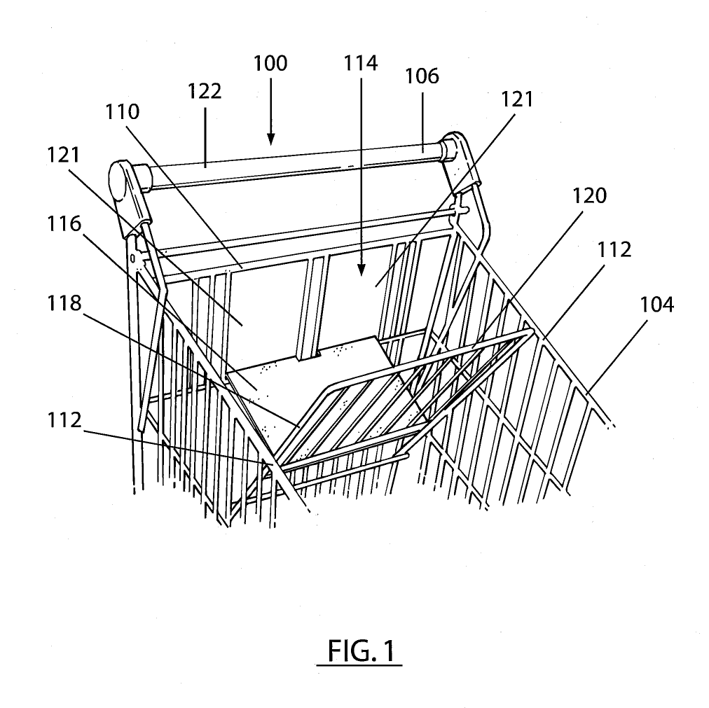

Referring to the drawings there is shown a bag assembly 20 according to a preferred embodiment of the present invention. The bag assembly 20 is intended for use with a shopping trolley 100 (known also as a shopping cart) comprising a wheeled base 102 supporting a basket portion 104 and a handle portion 106 for controlling and manoeuvring the shopping trolley, as shown in FIG. 1. The basket portion 104 comprises a front wall 108, a rear wall 110 and side walls 112, and incorporates a collapsible toddler seat 114. The toddler seat 114 comprises a seat portion 116 and a backrest portion 118 which cooperate for swinging movement between collapsed and operative conditions. The backrest portion 118 has an upper free end 120. Leg apertures 121 are incorporated in the toddler seat 114 through which the legs of the toddler can extend when in the seated position. The handle portion 106 is located at the rear of the shopping trolley 100 and includes a handle bar 122

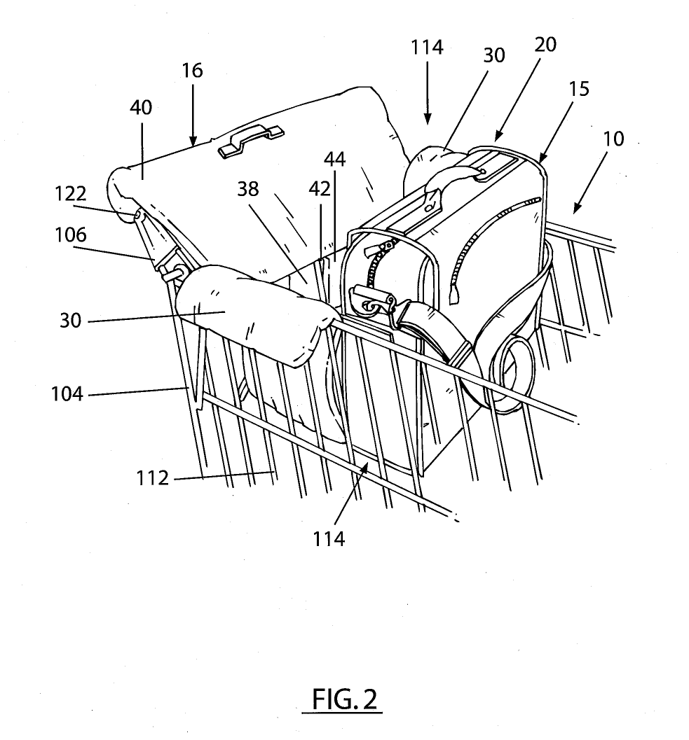

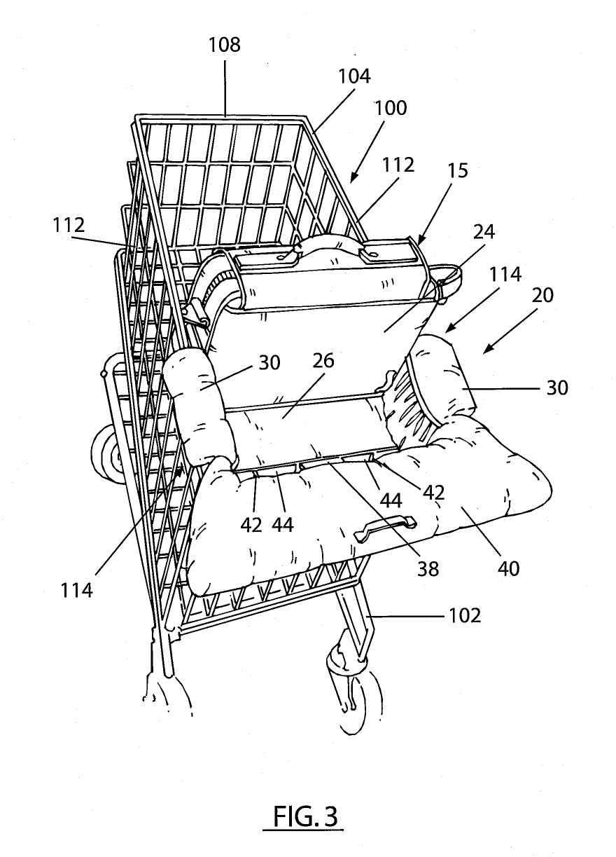

The bag assembly 20 according to the embodiment comprises a bag 15 having an insert 16 attached thereto. The insert 16 has stowed and operative conditions, as will be explained in more detail later. In the stowed condition, the insert 16 is accommodated within the bag 15. In the operative condition, the insert 16 extends from the bag 15 so that the insert and the bag can be so positioned as to substantially cover the internal surfaces of the toddler seat 114 as well as portions of the trolley, including nearby top edges of the basket portion 104 and the handlebar 122, as shown in FIGS. 2 and 3.

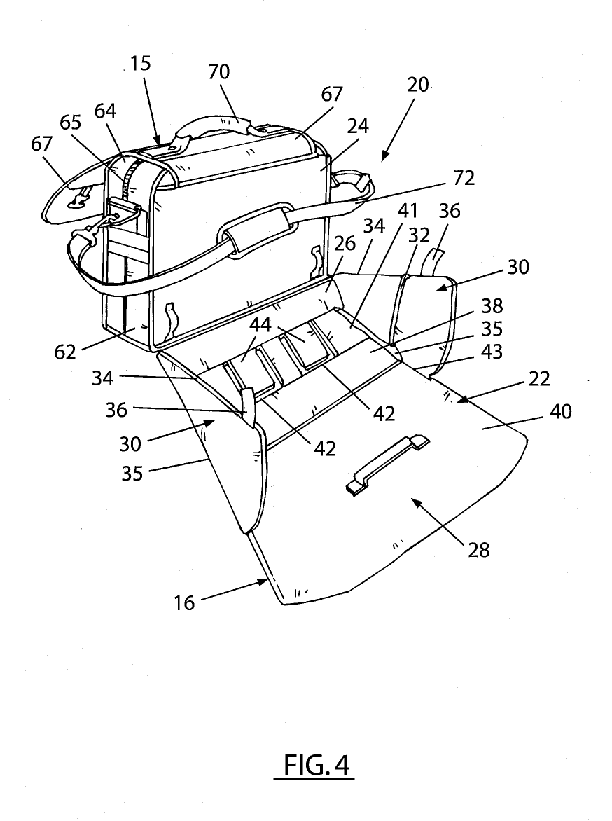

FIG. 4 shows an internal side 22 of the trolley insert 16. The trolley insert 16 includes a rectangular base portion 26 attached at one longitudinal side thereof to a back portion 24 of the bag 15. Extending from the other longitudinal side of the base portion 26 is a front portion 28 and side portions 30 extend from lateral sides of the base portion 26. The insert 16 substantially consists of flat padded material. An elasticised pocket 32 is formed at one of the side portions 30.

The back portion 24 of the bag 15 is rectangular in shape and extends from two corners of the base portion 26. The side portions 30 each include side edges 34, 35 that respectively extend from corners of the base portion 26, the side edges 34, 35 diverging from each other from the base portion 26. One side edge 35 of each side portion 30 is attached to the front portion 28. Hook straps 36 of hook and loop fasteners (e.g., VELCRO™) are attached to each of the free edges 34, the use of which will be described below.

The front portion 28 includes a leg section 38 adjacent the base portion 26 and a handlebar section 40 extending from the leg section 38. The leg section 38 includes side edges 41 which extend from the base portion 26, inwardly from corners of the base portion 26. The side edges 41 essentially diverge from each other until they join the edges of the handlebar section 40 which is rectangular.

The side edge 35 of each side portion 30 is spaced from the adjacent side edge 41 of the leg section 38 and is connected to the handlebar section 40 at junction 43.

Leg apertures 42 are formed in the leg section 38, which are substantially covered by flaps 44 extending from a side of the aperture 42 adjacent the base portion 26.

Essentially, the internal side 22 of the insert 16, together with the bag back portion 24 is shaped to cover the internal surfaces of the shopping trolley seat 114 for a toddler as will be further explained below.

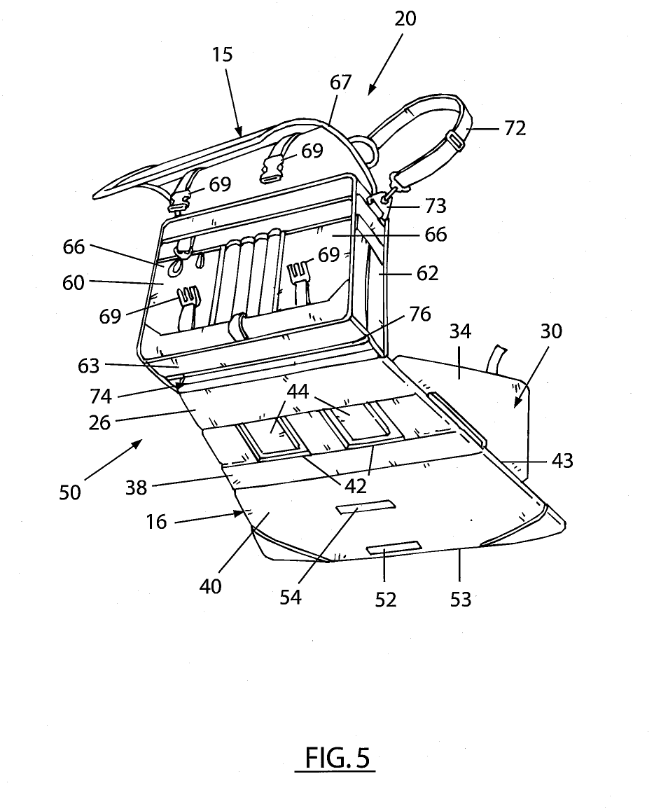

FIG. 5 is a perspective view showing an external side 50 of the trolley insert 16. The external side 50 substantially corresponds to the internal side 22. The external side 50 of the handlebar section 40 includes a strip of hook fastener 52 adjacent its distal end 53 and a strip of loop strap 54 parallel and spaced from the fastener 52 adjacent the leg section 38.

FIGS. 4 and 5 also show the bag 15 which includes the back portion 24 which is connected to a front panel 60 by side panels 62 and a top panel 64 thus forming a volume there between. This volume is partly covered by a bottom panel 63 which extends from the front panel 60 to about halfway toward the back panel 24. An internal panel (not shown) extends vertically upward from the bottom panel 63 and joined by a joining panel (not shown) which extends to the back panel 24 to partly close the volume and thus form an internal bag volume. A part of the volume which is not closed forms an inverted pocket 74 accessible via a bottom opening 76 defined by the gap between the bottom panel 63 and the back panel 24. This pocket 74 is thus bounded by the back portion 24, the internal panel, the joining panel and portions of the side panels 62.

The front panel 60 at its outside surface 61 includes storage pockets 66 as desired. The side panels 62 include attachments 73 for attaching a shoulder strap 72 thereto. The top panel 64 includes a zip 65 for accessing the internal bag volume. A further closure panel 67 extends from the back portion 24 and substantially covers the top panel 64 and the front panel 60 when attached to the front panel 60 via buckles 69. A hand strap 70 is attached to the closure panel 67. The side panels 62 also include loop straps 72 the purpose of which is explained below.

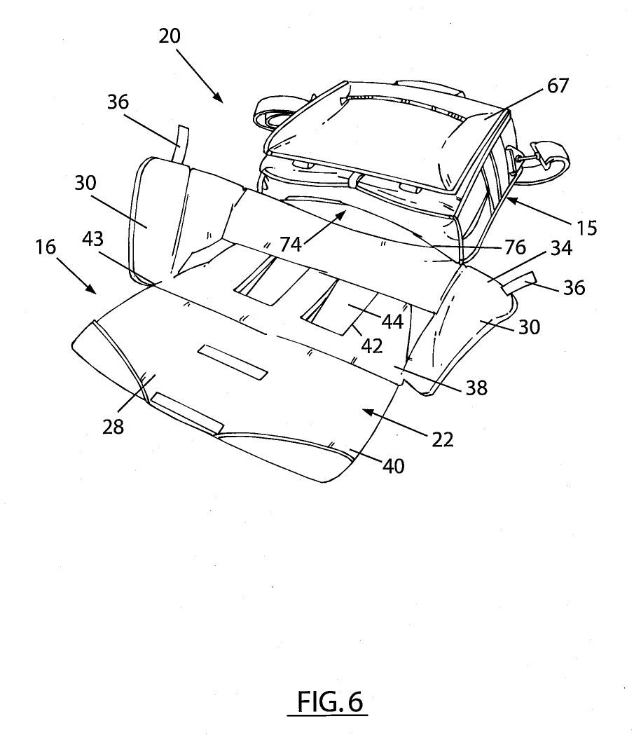

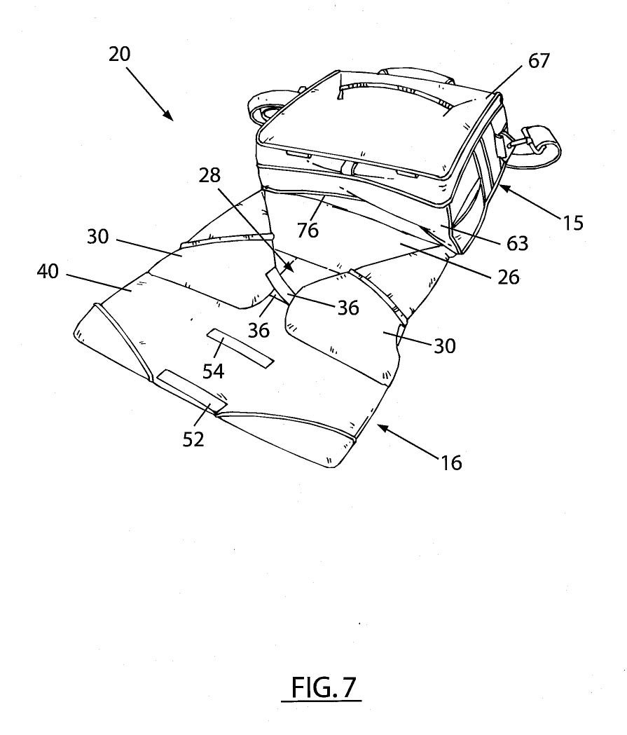

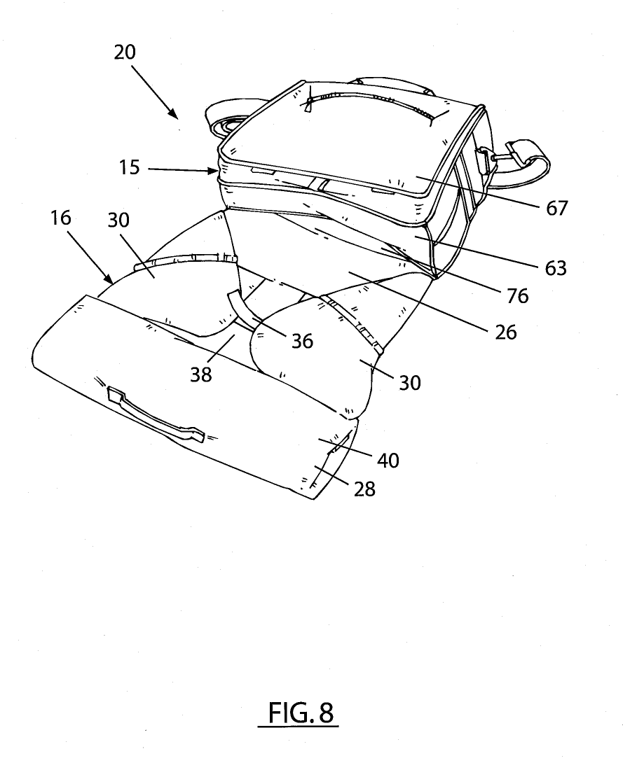

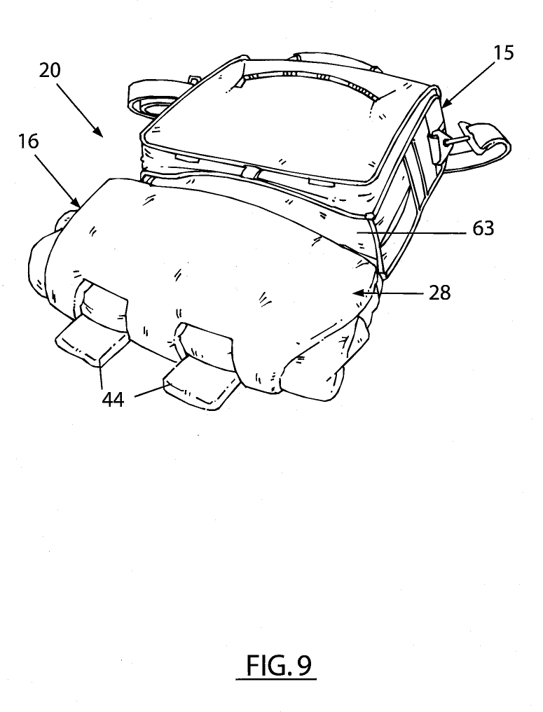

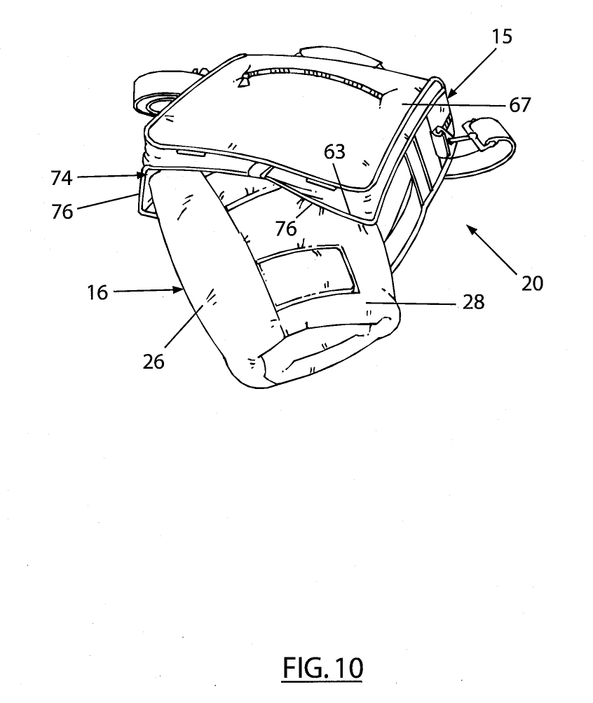

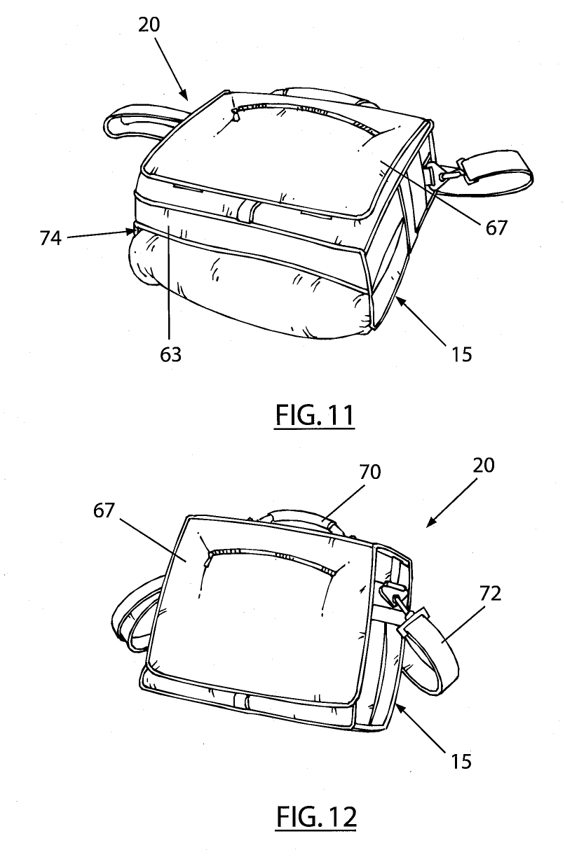

FIGS. 6 to 11 sequentially show the steps in folding the insert 16 into the pocket 74 for transport. In particular, FIG. 6 shows the insert 16 lay such that its internal side 22 faces upwardly. FIG. 6 also shows the bottom opening 76 of the pocket 74. FIG. 7 shows the step of folding the side portions 30 generally on top of the front portion 28. FIG. 8 shows the step of folding the handlebar section 40 generally onto itself. FIG. 9 shows the step of folding the folded front portion 28 on top of the side portions 30 and base portion 26. FIG. 10 shows the insertion of the folded front portion 28, side portions 30 and base section 26 into the pocket 74 through the opening 76, and FIG. 11 shows these portions fully inserted into the pocket 74.

As shown in FIG. 12, when the insert 16 is substantially fully inserted into the pocket 74, the bag assembly 20 has the appearance of a normal bag which can be carried as such via the hand strap 70 or shoulder strap 72.

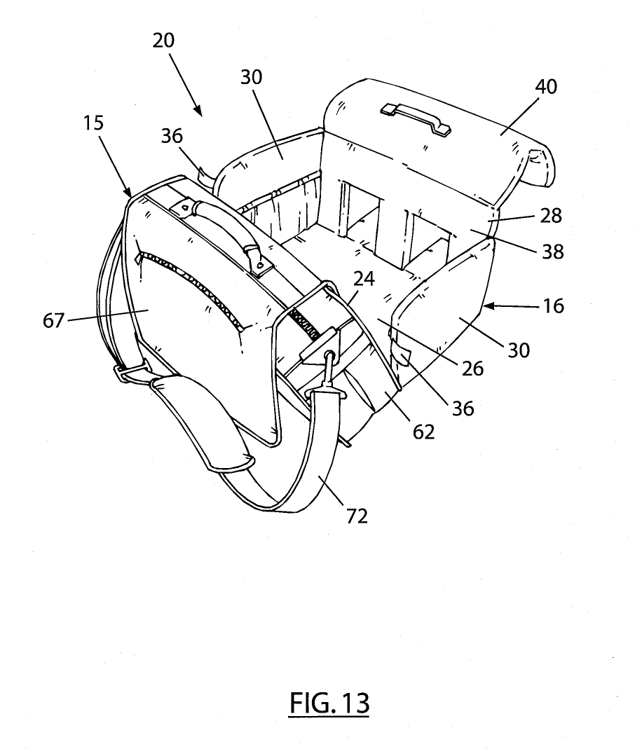

In use, the insert 16 is withdrawn from the pocket 74 within the bag 15 and is unfolded substantially as shown in FIG. 4. The insert 16 is installed into the toddler seat 114 of the shopping trolley 100 and the bag 15 is located on the backrest portion 118 of the toddler seat 114. More particularly, the bag 15 is positioned on the back rest portion 118 by presenting the opening 76 of the pocket 74 to the upper end 120 of the backrest portion 118 and lowering the bag 15 onto the backrest portion 118 such that the latter is received within the pocket 74. The base portion 26 covers the seat portion 116 of the toddle seat 114. The side portions 30 cover the sides of the toddler seat 114 and extend over the side edges of same, as shown in FIGS. 1 and 2. The hook straps 36 of the side portion edges 34 adjacent the back section 24 can then be attached to loop straps 74 of the side panels 62 (see FIG. 13). The front portion leg section 38 covers the front portion of the toddler seat 114 which the toddler faces in use. The apertures 42 correspond to the leg apertures 121 of the toddler seat 114 and the flaps 44 will extend through the leg apertures in use to provide covering and cushioning. The handlebar section 40 extends over the handlebar 122 of the trolley 100. The hook straps 52 are used to engage the loop straps 54 of the handlebar section 40 to secure same in place over the handlebar 122.

It can be seen that the embodiment provides a bag assembly 20 which is in the form of a combined bag 15 and insert 16, and which substantially completely covers the internal surfaces of the toddler seat 114, as well as adjacent portions of the trolley 100 including the top edges of the toddler seat and the handlebar 122, which the toddler may touch, lick, bite or otherwise contact when seated thereon. As the insert 16 is padded, the toddler is provided with a comfortable seat as well as protection from likely dirty portions of the trolley 100. The insert 16 can also be folded and inserted into the pocket 74 in a manner which allows the bag 15 to be easily carried and used. In addition, the bag 15 provides an internal bag volume and a number of pockets which are easily accessible whether the bag assembly 20 is being used as a bag only or in a trolley. The internal bag volume and pockets can be used to store items such as nappies, wipes, and toys, thereby reducing the number of bags required to be carried.

The bag 15 can be made from any suitable material as desired. The padded insert 16 can be made from flexible fabric material having a soft material insert made from foam, gel, high density polyurethane or similar suitable material. The bag and insert material are preferably durable, stain and water resistant, and the bag and insert can be printed with a design or logo. The bag volume can also be expanded as desired.

Although a preferred embodiment of the present invention has been described, it will be apparent to skilled persons that the invention can be embodied in other forms or that modification can be made to the above embodiments. For example, the pockets can be made bigger or the side portions 30 can include further pockets.

In an alternative embodiment, the invention can mainly consist of the insert but having a pocket formed in the back portion or front portion such that the remainder of the insert can be folded and inserted into the pocket.

In another possible modification, the insert 16 can be removably attached (detachable) to the bag 15 such as via a zipper, hook and loop fasteners or buttons to allow the insert to be washed if required or be used as a change mat.

The insert 16 can also be modified to include a safety belt. The safety belt will prevent a toddler from standing from the toddler seat. Further, the safety belt can include an electronic monitoring system, whereby unauthorised tampering or removing of the safety belt, or any attempt to do such, will trigger an alarm carried by the carer of the toddler. The alarm can include a flashing light or vibrations produced by a module attached to the wrist of the carer. This will notify the carer immediately of any such attempted tampering or removal of the safety belt, which may also include attempts by the toddler.

The alarm can also be activated if the carer's module moves beyond a predetermined desired distance from the toddler in the insert. The alarm will stop once the carer's module is within the desired distance. When the safety belt is fastened around the toddler, a light in the carer's module will indicate that the unit is operational. The safety belt is desirably only undone by having the carer's module in close proximity to the safety belt.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

1. A bag having a shopping trolley insert attached thereto adapted to substantially cover internal surfaces of a toddler seat of the shopping trolley in use, the bag having a pocket into which the insert can be received.

2. The bag according to claim 1 wherein the insert is foldable to assume a compact configuration for reception in the pocket.

3. The bag according to claim 1 wherein insert is attached adjacent a bottom portion of the bag.

4. The bag according to claim 3 wherein the pocket has an opening at or adjacent the bottom portion of the bag.

5. The bag according to claim 1 wherein the bag is configured to be received on a backrest portion of the toddler seat.

6. The bag according to claim 5 wherein the pocket is configured to receive the backrest portion.

7. The bag according to claim 1 wherein the insert comprises a base portion, a back portion and a front portion extending from opposite sides of the base portion.

8. The bag according to claim 7 wherein the insert further comprises side portions extending from lateral sides of the base portion.

9. The bag according to claim 7 wherein the front portion includes a leg section adjacent the base portion and a handlebar section extending from the leg section.

10. The bag according to claim 9 wherein the leg section includes leg apertures and flaps associated therewith extending from a side of the apertures adjacent the base portion.

11. A shopping trolley insert for substantially covering internal surfaces of a toddler seat of the shopping trolley in use, the insert having a base portion, a back portion and a front portion extending from opposite sides of the base portion, and a pocket formed at one side of the back portion, an opening of the pocket being adjacent the base portion such that the base portion and the front portion can be inserted into the pocket.

12. The shopping trolley insert according to claim 11 wherein the base portion and the front portion are adapted to be folded for insertion into the pocket.

13. The shopping trolley insert according to claim 12 wherein the back portion is configured to be received on a backrest portion of the toddler seat.

14. The shopping trolley insert according to claim 13 wherein the pocket is configured to receive the backrest portion.

15. The shopping trolley insert according to claim 11 wherein the back portion comprises a bag.

16. The shopping trolley insert according to claim 11 wherein the insert further comprises side portions extending from lateral sides of the base portion.

17. The shopping trolley insert according to claim 11 wherein the front portion includes a leg section adjacent the base portion and a handlebar section extending from the leg section.

18. The shopping trolley insert according to claim 17 wherein the leg section includes leg apertures and flaps associated therewith extending from a side of the apertures adjacent the base portion.

19. A shopping trolley insert having a base portion, a back portion and a front portion extending from opposite sides of the base portion, and a pocket formed at one side of the back portion or the front portion, an opening of the pocket being adjacent the base portion such that the base portion and the other of the back portion and the front portion can be folded and inserted into the pocket.
